(19) United States
(12) Patent Application Publication
(10) Pub. No.: US 2021/0398731 A1
(43) Pub. Date: Dec. 23, 2021

(54) THERMAL MANAGEMENT OF TOROIDAL TRANSFORMER ON A COLD PLATE

(71) Applicant: Hamilton Sundstrand Corporation, Charlotte, NC (US)

(72) Inventor: Hebri Vijayendra Nayak, Rockford, IL (US)

(21) Appl. No.: 16/909,443

(22) Filed: Jun. 23, 2020

(51) Int. Cl. H01F 27/10; H01F 27/02; F28F 3/12

(52) U.S. Cl. CPC H01F 27/10; F28F 3/12; H01F 27/022

(57) ABSTRACT

A cold plate and a method of manufacturing the cold plate involve a first side with a first surface, and a second side, opposite the first side, with a second surface opposite the first surface. The cold plate includes a flow channel formed between the first side and the second side, and a cavity integrally machined into the first surface of the first side. The cavity seats a toroidal transformer and is defined by a circular outside wall and a base whose surface is thinner than the first surface.

### BACKGROUND

Exemplary embodiments pertain to the art of thermal management and, in particular, to thermal management of a toroidal transformer on a cold plate.

A liquid cold plate is a platform for mounting power electronic components. The cold plate provides localized cooling to the components by transferring heat from the components mounted on one or both surfaces to the liquid flowing within. One of the components that may be placed on a cold plate is a toroidal transformer. A toroidal transformer is a power transformer with a toroidal core around which primary and secondary coils are wound. Power is transferred from the primary coil to the secondary coil. In general, voltage applied to the primary coil generates a magnetic field, which is coupled to the secondary coil. This, in turn, generates voltage in secondary coil.

### BRIEF DESCRIPTION

In one embodiment, a cold plate includes a first side with a first surface, and a second side, opposite the first side, with a second surface opposite the first surface. The cold plate also includes a flow channel formed between the first side and the second side, and a cavity integrally machined into the first surface of the first side. The cavity seats a toroidal transformer and is defined by a circular outside wall and a base whose surface is thinner than the first surface.

Additionally or alternatively, in this or other embodiments, the cold plate also includes an inlet to channel coolant into the flow channel.

Additionally or alternatively, in this or other embodiments, the cold plate also includes an outlet to channel the coolant out of the flow channel.

Additionally or alternatively, in this or other embodiments, a thickness of the first side is greater than a thickness of the second side.

Additionally or alternatively, in this or other embodiments, the cavity includes outer fins protruding from the outside wall radially toward a center of the cavity.

Additionally or alternatively, in this or other embodiments, the cavity includes a center post in a center of the cavity.

Additionally or alternatively, in this or other embodiments, the cavity includes inner fins protruding radially from the center post into the cavity toward the outside wall.

Additionally or alternatively, in this or other embodiments, a gap between the inner fins and the outer fins is sized to accommodate the toroidal transformer and an encapsulant surrounding the toroidal transformer.

Additionally or alternatively, in this or other embodiments, the cold plate is machined from aluminum or copper.

In another embodiment, a method of fabricating a cold plate includes machining a flow channel between a first side with a first surface and a second side, opposite the first side, with a second surface opposite the first surface. The method also includes machining a cavity into the first surface of the first side. The cavity seats a toroidal transformer. Machining the cavity includes defining the cavity with a circular outside wall and a base whose surface is thinner than the first surface.

Additionally or alternatively, in this or other embodiments, the method also includes forming an inlet to channel coolant into the flow channel.

Additionally or alternatively, in this or other embodiments, the method also includes forming an outlet to channel the coolant out of the flow channel.

Additionally or alternatively, in this or other embodiments, the machining the flow channel includes positioning the flow channel such that a thickness of the first side is greater than a thickness of the second side.

Additionally or alternatively, in this or other embodiments, the machining the cavity includes machining outer fins protruding from the outside wall radially toward a center of the cavity.

Additionally or alternatively, in this or other embodiments, the machining the cavity includes machining a center post in a center of the cavity.

Additionally or alternatively, in this or other embodiments, the machining the cavity includes machining inner fins protruding radially from the center post into the cavity toward the outside wall.

Additionally or alternatively, in this or other embodiments, the machining the cavity includes sizing a gap between the inner fins and the outer fins to accommodate the toroidal transformer and an encapsulant surrounding the toroidal transformer.

Additionally or alternatively, in this or other embodiments, the fabricating the cold plate includes machining aluminum or copper.

In yet another embodiment, a system includes a cold plate. The cold plate includes a first side with a first surface, and a second side, opposite the first side, with a second surface opposite the first surface. The cold plate also includes a flow channel formed between the first side and the second side, and a cavity integrally machined into the first surface of the first side. The cavity is defined by a circular outside wall and a base whose surface is thinner than the first surface. The system also includes a toroidal transformer seated in the cavity.

Additionally or alternatively, in this or other embodiments, the system also includes encapsulant to surround the toroidal transformer in the cavity such that the toroidal transformer does not directly contact the cavity.

### BRIEF DESCRIPTION OF THE DRAWINGS

The following descriptions should not be considered limiting in any way. With reference to the accompanying drawings, like elements are numbered alike:

FIG. 1 is an exploded view showing a cold plate used for thermal management of a toroidal transformer according to one or more embodiments;

FIG. 2 shows aspects of the cavity used to perform thermal management of the toroidal transformer on a cold plate according to one or more embodiments;

FIG. 3 shows a toroidal transformer in the cavity used for thermal management according to one or more embodiments;

FIG. 4 shows the toroidal transformer in the cavity of the cold plate for thermal management according to one or more embodiments;

FIG. 5 is a cross-sectional view through the cavity used for thermal management of the toroidal transformer according to one or more embodiments;

FIG. 6 is a cross-sectional view through the toroidal transformer in the cavity used for thermal management of the toroidal transformer according to one or more embodiments;

FIG. 7 shows heat flow from the toroidal transformer according to one or more embodiments; and

FIG. 8 shows heat flow within the cavity that performs thermal management of the toroidal transformer according to one or more embodiments.

### DETAILED DESCRIPTION

A detailed description of one or more embodiments of the disclosed apparatus and method are presented herein by way of exemplification and not limitation with reference to the Figures.

As previously noted, a cold plate can support and cool electronic components. Embodiments of the systems and methods detailed herein relate to thermal management of a toroidal transformer on a cold plate. Specifically, a cavity is machined as an integral part of the cold plate to accommodate the toroidal transformer. Fins that are formed within the cavity facilitate radial heat transfer both within and outside the core of the toroidal transformer. The surface of the cold plate transfers the heat from the toroidal transformer to the liquid flowing within the body of the cold plate.

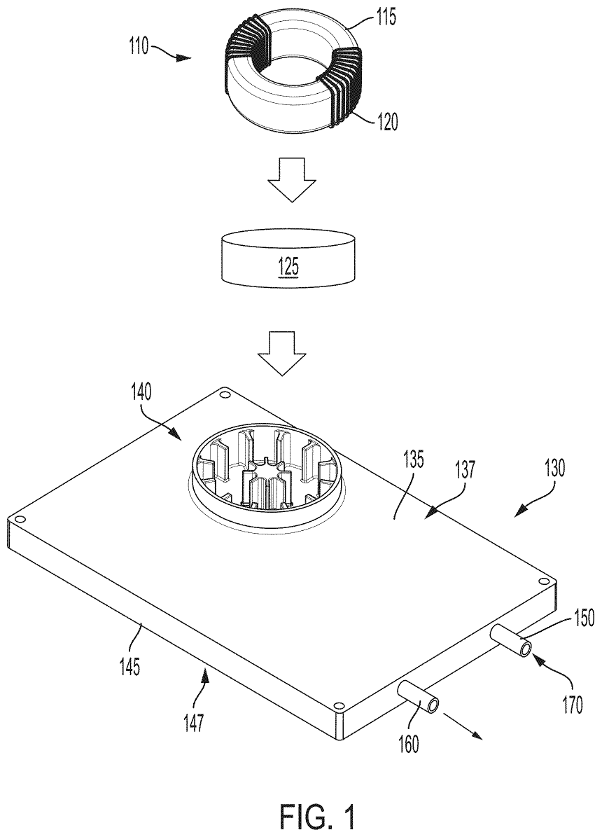

FIG. 1 is an exploded view showing a cold plate 130 used for thermal management of a toroidal transformer 110 according to one or more embodiments. The exploded view shows encapsulant 125, referred to also as potting material, and a toroidal transformer 110 above the cold plate 130. The encapsulant 125 is thermally conductive but electrically insulating. Thus, the encapsulant 125 encapsulates the toroidal transformer 110 within a cavity 140 and separates the toroidal transformer 110 from the cavity 140 electrically while conducting heat from the toroidal transformer 110 to the cavity 140. The cold plate 130 includes the cavity 140 machined within a surface 135 of a first side 137 for seating the toroidal transformer 110. The toroidal transformer 110 includes a core 115 that is typically made of ferrite material, for example. The two sets of windings 120 around the core 115 may be copper. The core 115 and the windings 120 dissipate heat. This heat is removed according to one or more embodiments in order to maintain the temperature of the toroidal transformer 110 below a predefined limit.

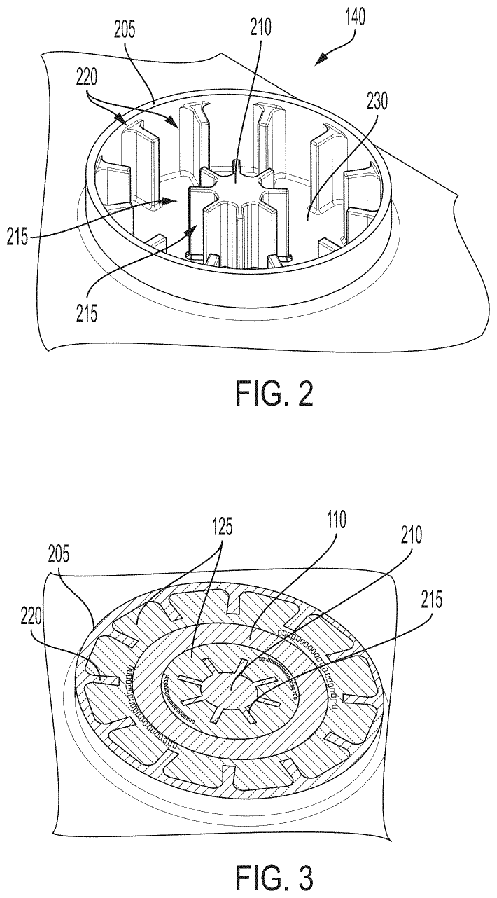

The cavity 140 of the cold plate 130 that seats the toroidal transformer 110 is further detailed with reference to FIG. 2. The cold plate 130 has a second surface 145, opposite the surface 135, on a second side 147. As previously noted, components could be attached to both the surface 135 and second surface 145 of the cold plate 130. According to exemplary embodiments, the thickness of the first side 137 is greater than the thickness of the second side 147 to accommodate the cavity 140, and components are only disposed on the surface 135. Thus, the exemplary cold plate 130 may be referred to as a one-sided

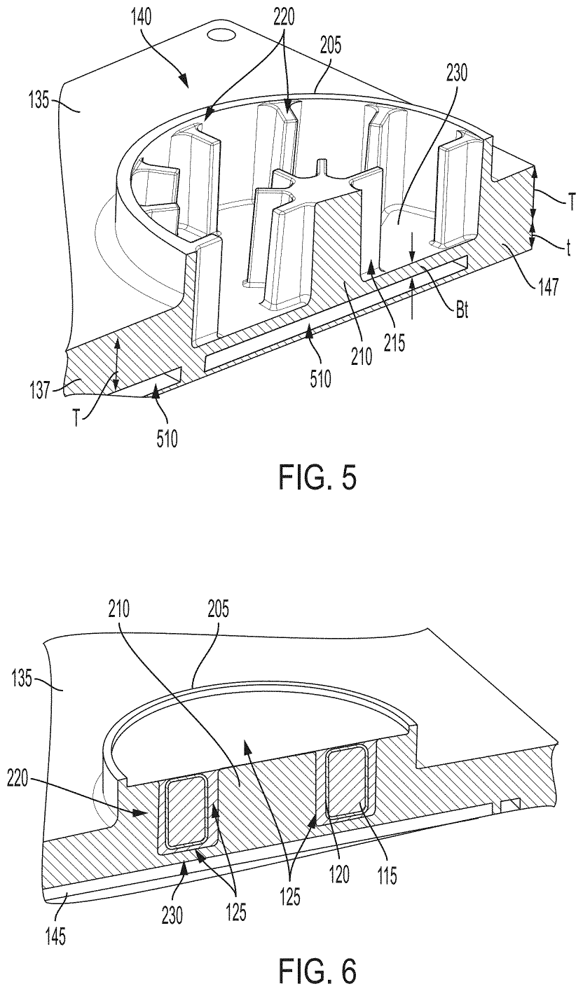

An inlet 150 facilitates an inflow of coolant 170 through a flow channel 510 (FIG. 5) within the cold plate 130. The flow channel 510 may be formed as a pipe with fins for additional heat transfer. The flow channel 510 within the cold plate 130 may be formed in a pattern to allow the coolant 170 to absorb heat from different areas of the surface 135 as it moves from the inlet 150 to the outlet 160. That is, heat from the components on the surface 135, or both surfaces 135, 145, is conducted into the coolant 170, which carries the heat out via the outlet 160. Exemplary coolants 170 include ethylene glycol with water (EGW), propylene glycol with water (PGW), and polyalphaolefin (PAO).

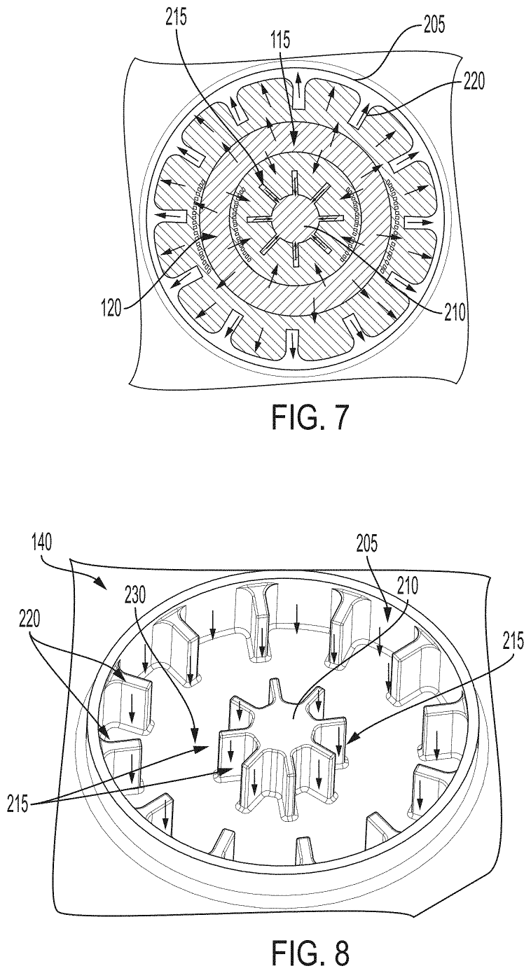

FIG. 2 shows aspects of the cavity 140 used to perform thermal management of the toroidal transformer 110 on a cold plate 130 according to one or more embodiments. As previously noted, the cavity 140 is machined as an integral part of the cold plate 130. The cold plate 130 and, thus, the cavity 140 may be aluminum or copper, for example. The cavity 140 is defined by a circular outside wall 205 with outer fins 220 that protrude into the cavity 140 and are positioned to be concentrically outside the toroidal transformer 110 although they do not contact the toroidal transformer 110. A center post 210 supports a set of inner fins 215 that protrude into the cavity 140 and are positioned to be concentrically inside the toroidal transformer although they do not contact the toroidal transformer 110. The floor or base 230 of the cavity 140 ultimately conducts the heat dissipated by the toroidal transformer 110, the heat source, to the coolant 170, the heat sink. This is further discussed with reference to FIGS. 5 and 7.

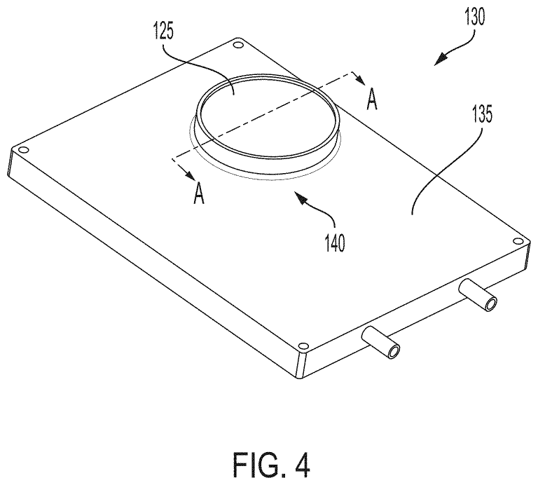

FIG. 3 shows a toroidal transformer 110 in the cavity 140 used for thermal management according to one or more embodiments. The view in FIG. 3 is prior to the addition of a layer of encapsulant 125 that covers the cavity 140, as shown in FIG. 4. That is, the view in FIG. 3 can be regarded as a cross-sectional view with the top layer of encapsulant 125 removed from the cavity 140. Exemplary encapsulants 125 include Stycast 2850, Sylgard 170, and Scotchcast 280. As previously noted, the outer fins 220 protruding from the outside wall 205 do not contact the toroidal transformer 110. Instead, encapsulant 125 fills a gap between the outside wall 205 and each of the outer fins 220 and the toroidal transformer 110. As also previously noted, the inner fins 215 protruding from the center post 210 do not contact the toroidal transformer 110. Instead, encapsulant 125 fills a gap between the center post 210 and each of the inner fins 215 and the toroidal transformer 110.

FIG. 4 shows the toroidal transformer 110 in the cavity 140 of the cold plate 130 for thermal management according to one or more embodiments. As FIG. 4 indicates, the toroidal transformer 110 is not visible because of a layer of encapsulant 125 that covers the cavity 140. As further discussed with reference to FIG. 6, the encapsulant 125 is not only above the toroidal transformer 110, as shown in FIG. 4, and surrounding the toroidal transformer 110, as shown in FIG. 3, but the encapsulant 125 is also beneath the toroidal transformer 110.

It should be understood that other components, additional to the toroidal transformer 110, may be mounted on the surface 135 of the cold plate 130. Another one or more cavities 140 to seat another one or more toroidal transformers 110 may also be integrated into the surface 135. The other components, including any other toroidal transformers 110, are placed on the surface 135 in consideration of the heat that they dissipate and the cooling capacity of the cold plate 130. The overall cooling capacity of the cold plate 130 is based on several factors including the size and thickness of the surface 135 and the temperature of the coolant 170. The cross-section indicated through A-A in shown in FIG. 5.

FIG. 5 is a cross-sectional view through the cavity 140 used for thermal management of the toroidal transformer 110 according to one or more embodiments. The cross-section through A-A indicated in FIG. 4 is shown. The cross-sectional view indicates that the thickness T of the first side 137 of the cold plate 130 that includes the cavity 140 is greater than the thickness t of the second side 147 of the cold plate 130. Sections of the flow channel 510 are visible within the cold plate 130. As previously noted, the cavity 140 is machined to be an integral part of the cold plate 130. Thus, the outside wall 205, center post 210, inner fins 215, and outer fins 220 are all machined from the material of the cold plate 130. As a result, thermal interface resistances are eliminated between different aspects of the cavity 140. The absence of thermal interface resistance maximizes heat dissipation from the source (i.e., the toroidal transformer 110). As previously noted, the base 230 of the cavity 140 ultimately conducts the heat from the cavity 140 to the heat sink, the coolant 170. The inner fins 215 and outer fins 220 define conduction paths for the heat from the toroidal transformer 110 (via the encapsulant 215) to reach the base 230, as further discussed with reference to FIG. 8. The thickness Bt of this base 230 is minimized, with consideration to structural integrity, to maximize heat transfer from the base 230 to the coolant 170 flowing through the flow channel 510.

FIG. 6 is a cross-sectional view through the toroidal transformer 110 in the cavity 140 used for thermal management of the toroidal transformer 110 according to one or more embodiments. As indicated, the encapsulant 125 completely surrounds the toroidal transformer 110. That is, the encapsulant 125 is below the toroidal transformer 110 between the toroidal transformer 110 and the base 230 of the cavity 140. The encapsulant 125 is concentrically within the toroidal transformer 110 between the toroidal transformer 110 and the center post 210 and inner fins 215. The encapsulant 125 is concentrically outside the toroidal transformer 110 between the toroidal transformer 110 and the outside wall 205 and outer fins 220 (not visible in FIG. 6). The encapsulant 215 conducts heat away from the toroidal transformer 110 and into the inner fins 215 and outer fins 220, as further discussed with reference to FIG. 7.

FIG. 7 shows heat flow from the toroidal transformer 110 according to one or more embodiments. The view in FIG. 7 is similar to the view in FIG. 3 with heat flow indicated by arrows. As one set of arrows shows, heat flows radially outward from the core 115 and the windings 120 of the toroidal transformer 110 to encapsulant 125. The encapsulant 125 conducts the heat to outer fins 220 and the outside wall 205. As another set of arrows shows, heat also flows radially inward from the core 115 and the windings 120 of the toroidal transformer 110 to encapsulant 125. The encapsulant 125 conducts the heat to inner fins 215 and the center post 210.

FIG. 8 shows heat flow within the cavity 140 that performs thermal management of the toroidal transformer 110 according to one or more embodiments. The view in FIG. 8 is similar to the view in FIG. 2 with heat flow indicated by arrows. As the arrows indicate, heat flow is down the outside wall 205, center post, 210, inner fins 215, and outer fins 220 to the base 230 of the cavity 140. As previously noted, the heat in the base 230 is conducted to the coolant 170 that flows below the base 230 through the flow channel 510. This coolant 170 is the ultimate heat sink of the system mounted on the cold plate 130. The design of the cavity 140 provides multiple heat transfer paths to dissipate heat from the toroidal transformer 110, as indicated in FIGS. 7 and 8. This feature, coupled with the absence of thermal interface resistance in the cavity 140, facilitates the removal of a relatively larger amount of heat from the toroidal transformer 110 as compared with a cold plate 130 that does not include the cavity 140.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A cold plate comprising:
a first side with a first surface;
a second side, opposite the first side, with a second surface opposite the first surface;
a flow channel formed between the first side and the second side; and
a cavity integrally machined into the first surface of the first side, wherein the cavity is configured to seat a toroidal transformer and is defined by a circular outside wall and a base whose surface is thinner than the first surface.

2. The cold plate according to claim 1, further comprising an inlet configured to channel coolant into the flow channel.

3. The cold plate according to claim 2, further comprising an outlet configured to channel the coolant out of the flow channel.

4. The cold plate according to claim 1, wherein a thickness of the first side is greater than a thickness of the second side.

5. The cold plate according to claim 1, wherein the cavity includes outer fins protruding from the outside wall radially toward a center of the cavity.

6. The cold plate according to claim 5, wherein the cavity includes a center post in a center of the cavity.

7. The cold plate according to claim 6, wherein the cavity includes inner fins protruding radially from the center post into the cavity toward the outside wall.

8. The cold plate according to claim 7, wherein a gap between the inner fins and the outer fins is sized to accommodate the toroidal transformer and an encapsulant surrounding the toroidal transformer.

9. The cold plate according to claim 1, wherein the cold plate is machined from aluminum or copper.

10. A method of fabricating a cold plate, the method comprising:
machining a flow channel between a first side with a first surface and a second side, opposite the first side, with a second surface opposite the first surface; and
machining a cavity into the first surface of the first side, wherein the cavity is configured to seat a toroidal transformer and the machining the cavity includes defining the cavity with a circular outside wall and a base whose surface is thinner than the first surface.

11. The method according to claim 10, further comprising forming an inlet configured to channel coolant into the flow channel.

12. The method according to claim 11, further comprising forming an outlet configured to channel the coolant out of the flow channel.

13. The method according to claim 10, wherein the machining the flow channel includes positioning the flow channel such that a thickness of the first side is greater than a thickness of the second side.

14. The method according to claim 10, wherein the machining the cavity includes machining outer fins protruding from the outside wall radially toward a center of the cavity.

15. The method according to claim 14, wherein the machining the cavity includes machining a center post in a center of the cavity.

16. The method according to claim 15, wherein the machining the cavity includes machining inner fins protruding radially from the center post into the cavity toward the outside wall.

17. The method according to claim 16, wherein the machining the cavity includes sizing a gap between the inner fins and the outer fins to accommodate the toroidal transformer and an encapsulant surrounding the toroidal transformer.

18. The method according to claim 11, wherein the fabricating the cold plate includes machining aluminum or copper.

19. A system comprising:
a cold plate comprising:
a first side with a first surface,
a second side, opposite the first side, with a second surface opposite the first surface,
a flow channel formed between the first side and the second side, and
a cavity integrally machined into the first surface of the first side, wherein the cavity is defined by a circular outside wall and a base whose surface is thinner than the first surface; and
a toroidal transformer seated in the cavity.

20. The system according to claim 19, further comprising encapsulant configured to surround the toroidal transformer in the cavity such that the toroidal transformer does not directly contact the cavity.
